(19) United States
(12) Patent Application Publication
(10) Pub. No.: US 2021/0396543 A1
(43) Pub. Date: Dec. 23, 2021

(54) INFORMATION PROCESSING APPARATUS, INFORMATION PROCESSING METHOD, AND PROGRAM

(71) Applicant: SONY GROUP CORPORATION, TOKYO (JP)

(72) Inventors: HAJIME WAKABAYASHI, TOKYO (JP); HIROTAKE ICHIKAWA, TOKYO (JP)

(21) Appl. No.: 17/288,903

(22) PCT Filed: Sep. 13, 2019
(86) PCT No.: PCT/JP2019/036109

§ 371 Date: Apr. 26, 2021

(30) Foreign Application Priority Data
Nov. 6, 2018 (JP) 2018-208894

(51) Int. Cl. G01C 21/00; G01C 21/32; G06K 9/46; G01C 21/12

(52) U.S. Cl. CPC G01C 21/3811; G01C 21/12; G06K 9/4609; G01C 21/32

(57) ABSTRACT

According to the present disclosure, an information processing apparatus including an imaging request unit (160) configured to issue a request for imaging capturing for updating an environmental map including image information, and an environmental map update unit (135) configured to update the environmental map on a basis of a captured image captured in accordance with the request for the image capturing is provided. With this configuration, an environmental map is updated on the basis of a captured image captured in accordance with a request for image capturing. Thus, it becomes possible to accurately update information regarding an environmental map, by a simple method.

### TECHNICAL FIELD

The present disclosure relates to an information processing apparatus, an information processing method, and a program.

### BACKGROUND ART

For example, Patent Document 1 described below has conventionally described that a global map representing the position of an object in a real space in which a plurality of users does activities is updated on the basis of position data of an object that is included in a local map generated for representing the position of a nearby object.

### CITATION LIST

### Patent Document

Patent Document 1: Japanese Patent Application Laid-Open No. 2011-186808

### SUMMARY OF THE INVENTION

### Problems to be Solved by the Invention

An environmental map representing the position of an object in the real space as described in Patent Document 1 described above has such a problem that information becomes older as an object in the real space changes, and convenience for the user declines. In Patent Document 1 described above, the global map is updated on the basis of position data of an object that is included in the local map representing the position of a nearby object detectable by a device of one user among a plurality of users. Such a method is expected to fail to optimally update the environmental map in cases such as a case where an environmental map supports a broad region.

In view of the foregoing, it has been demanded to accurately update information regarding an environmental map, by a simple method.

### Solutions to Problems

According to the present disclosure, an information processing apparatus including an imaging request unit configured to issue a request for imaging capturing for updating an environmental map including image information, and an environmental map update unit configured to update the environmental map on the basis of a captured image captured in accordance with the request for the image capturing is provided.

Furthermore, according to the present disclosure, an information processing method including issuing a request for imaging capturing for updating an environmental map including image information, and updating the environmental map on the basis of a captured image captured in accordance with the request for the image capturing is provided.

Furthermore, a program for causing a computer to function as a means for issuing a request for imaging capturing for updating an environmental map including image information, and a means for updating the environmental map on the basis of a captured image captured in accordance with the request for the image capturing is provided.

### BRIEF DESCRIPTION OF DRAWINGS

FIG. 1 is a schematic diagram illustrating a configuration of a system 1000 according to an embodiment of the present disclosure.

FIG. 2 is a schematic diagram illustrating processing performed by an update necessity determination unit 150 and an imaging request unit 160.

FIG. 3 is a schematic diagram illustrating processing related to validity check of an image and a calculation request.

FIG. 4 is a schematic diagram illustrating processing related to verification of a calculation result, update of an environmental map, and allocation of a reward.

FIG. 5 is a schematic diagram illustrating a case where a reward is exchanged into another value.

FIG. 6A is a schematic diagram illustrating a UI of an imaging request.

FIG. 6B is a schematic diagram illustrating a UI of an imaging request.

FIG. 7 is a schematic diagram illustrating a portion in an environmental map that is required to be updated.

FIG. 8 is a flowchart illustrating processing of performing similarity determination of images.

FIG. 9 is a flowchart illustrating processing of performing clearness determination of an image.

FIG. 10 is a flowchart illustrating processing performed when it is determined whether or not a moving object is included in an image.

FIG. 11 is a flowchart illustrating processing of matching and relative position calculation.

FIG. 12 is a flowchart illustrating processing of a verification method of relative positions of images.

### MODE FOR CARRYING OUT THE INVENTION

Hereinafter, a preferred embodiment of the present disclosure will be described in detail with reference to the attached drawings. Note that, in this specification and the drawings, the redundant description will be omitted by allocating the same reference numerals to the components having substantially the same functional configuration.

Note that the description will be given in the following order.

1. Overview of Present Disclosure

2. Configuration Example of System

2.1. Overall Configuration of System and Estimation of Relative Position

2.2. Determination of Update Necessity and Imaging Request

2.3. Validity Check of Image and Calculation Request

2.4. Verification of Calculation Result, Update of Environmental Map, and Allocation of Reward

2.5. Exchange of Reward

3. Specific Processing Performed in System

3.1. Similarity Determination of Images

3.2. Clearness Determination of Image

3.3. Determination as to Whether or Not Moving Object Is Included in Image

3.4. Matching and Relative Position Calculation

3.5. Verification Method of Relative Position

### 1. Overview of Present Disclosure

The present disclosure relates to the update of an environmental map. An environmental map assumed in the present disclosure is information for identifying a self-position by a device including various sensors such as an AR device, for example. As such information, for example, information that uses a GPS, information that uses wireless communication, information that uses matching that uses feature points of an image, and the like can be assumed. As information that uses wireless communication, for example, information that uses a list of access points (APs) of Wi-Fi, and information that uses the radio field intensity of beacons of Bluetooth (registered trademark) can be given.

An environmental map that is based on these pieces of information is preliminarily created, and if an actual environment changes, the accuracy of the environmental map declines. Furthermore, if an actual environment drastically changes, the environmental map can become unusable. In particular, if the accuracy of the environmental map declines, it becomes difficult to estimate a self-position on the basis of the environmental map.

Examples of an environmental change include an event such as a change in an AP of Wi-Fi or a change in radio field intensity of Bluetooth (registered trademark), and a variation in transmission source. Furthermore, in a case where the GPS is used, examples of an environmental change include an event such as blocking of a GPS signal by a construction such as a building.

On the other hand, in a case where feature points of images is used, examples of an environmental change can include a case where an actual landscape of a captured image changes from a state at the time of image capturing (rebuilding of a construction, shop swapping, and the like). The method that uses images has such an advantage that the method can be used even in a location to which wireless radio waves are not delivered.

The present disclosure focuses attention on the advantage of the method that uses images, and uses a method of updating an environmental map in such a manner as to be adaptable to an environmental change. After environmental map information is created, for maintaining the accuracy thereof, a periodical update work becomes necessary. Thus, an image of a location desired to be updated is captured again, and calculation for importing an imaging result into existing data is executed. However, in a case where image capturing is performed again, it is necessary to go to a site for image capturing. Furthermore, if a supported range is large, a processing amount in calculation for importing an imaging result into existing data increases. As a range supported by an environmental map becomes larger, it becomes difficult to perform these works only by an organization or an association that manages maps.

Thus, in the present disclosure, by requesting a user of an environmental map to perform the following works, the environmental map is updated.

(1) Image capturing of location desired to be updated

(2) Execution of calculation for importing imaging result of location desired to be updated, into existing data

As a method of a request, any method or a plurality of methods of a method of directly issuing a request to a user, a method of disclosing requestable items, that is to say, a list of items required to be updated, and prompting a user to select an item, and a method of an administrator of the map executing update can be considered. Moreover, in accordance with a request, a reward is allocated to a user who has achieved the request. The reward is assumed to be exchangeable into another value.

### 2. Configuration Example of System

### 2.1. Overall Configuration of System and Estimation of Relative Position

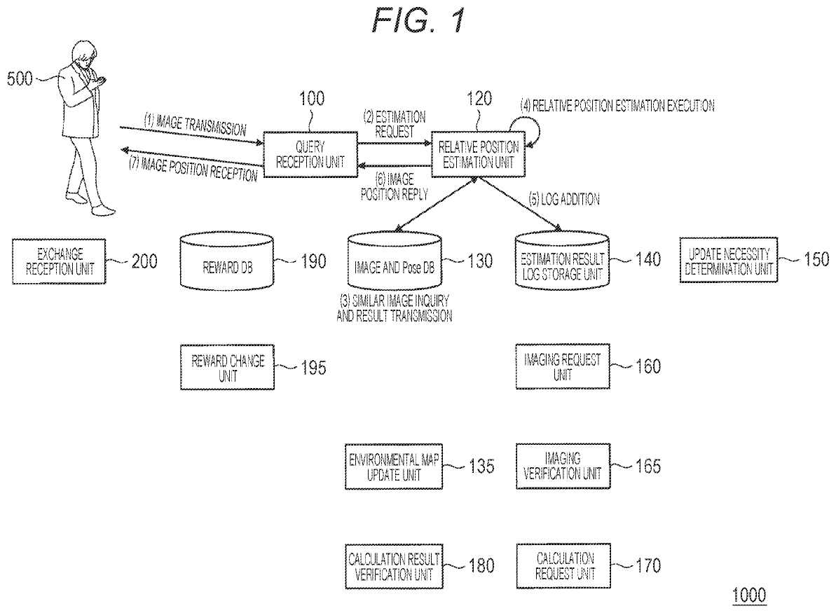

FIG. 1 is a schematic diagram illustrating a configuration of a system 1000 according to an embodiment of the present disclosure. As illustrated in FIG. 1, the system 1000 includes a query reception unit 100, a relative position estimation unit 120, an image database 130, an environmental map update unit 135, an estimation result log storage unit 140, an update necessity determination unit 150, an imaging request unit 160, an imaging verification unit 165, a calculation request unit 170, a calculation result verification unit 180, a reward database 190, a reward change unit 195, and an exchange reception unit 200. Note that the system 1000 may include a server, and the server may be provided on a cloud. Furthermore, each component of the system 1000 illustrated in FIG. 1 can include a central processing unit such as a CPU, and a program (software or circuit (hardware)) for operating the central processing unit.

FIG. 1 illustrates a case where a user 500 who desired to recognize a self-position transmits an image to the system 1000, and acquires the position corresponding to the image, from the system 1000. On the basis of information regarding environmental maps accumulated in the image database 130, the system 1000 estimates a relative position corresponding to the image transmitted from the user 500. In FIG. 1, an arrow indicates processing related to the estimation of a relative position. The user 500 captures an image of the periphery of a self-position using a device such as a smartphone, for example, and transmits image data to the system 1000.

The query reception unit 100 of the system 1000 receives the image transmitted from the user 500. On the basis of images of environmental maps accumulated in the image database 130, the query reception unit 100 requests the relative position estimation unit 120 to estimate relative positions of the image captured by the user 500 and images of environmental maps.

The relative position estimation unit 120 inquires of the image database 130 whether or not there is an image similar to the image captured by the user 500. The image database 130 transmits a result of the inquiry from the relative position estimation unit 120, to the relative position estimation unit 120. Then, the relative position estimation unit 120 estimates relative positions of images similar to the image captured by the user 500 that have been extracted from the image database 130, and the image captured by the user 500. Because the positions of the respective images of environmental maps accumulated in the image database 130 are identified, matching of similar images and the image captured by the user 500 is performed, and if matching succeeds, the position of the image captured by the user 500 can be estimated. In the relative position estimation unit 120, the number of feature points in images in matching, and reprojection error values are stored.

The position of the image captured by the user 500 that has been estimated by the relative position estimation unit 120 is transmitted to the query reception unit 100, and transmitted from the query reception unit 100 to the user 500. Therefore, the user 500 can recognize a self-position. Accordingly, by using an environmental map held by the system 1000, the user 500 can recognize the position of itself. Furthermore, by using the environmental map, it is also possible to perform a desired operation such as search for a route to a destination.

Furthermore, the relative position estimation unit 120 transmits an estimation result of the position of the image captured by the user 500 to the estimation result log storage unit 140, and stores the estimation result thereinto. The relative position estimation unit 120 stores, into the estimation result log storage unit 140, an estimation result (log) including information indicating that estimation has been performed well, information indicating that estimation has not been performed well, and the like. Specifically, information regarding an estimation result includes the number of feature points in images in matching, a reprojection error, the number of matchings, and the like.

### 2.2. Determination of Update Necessity and Imaging Request

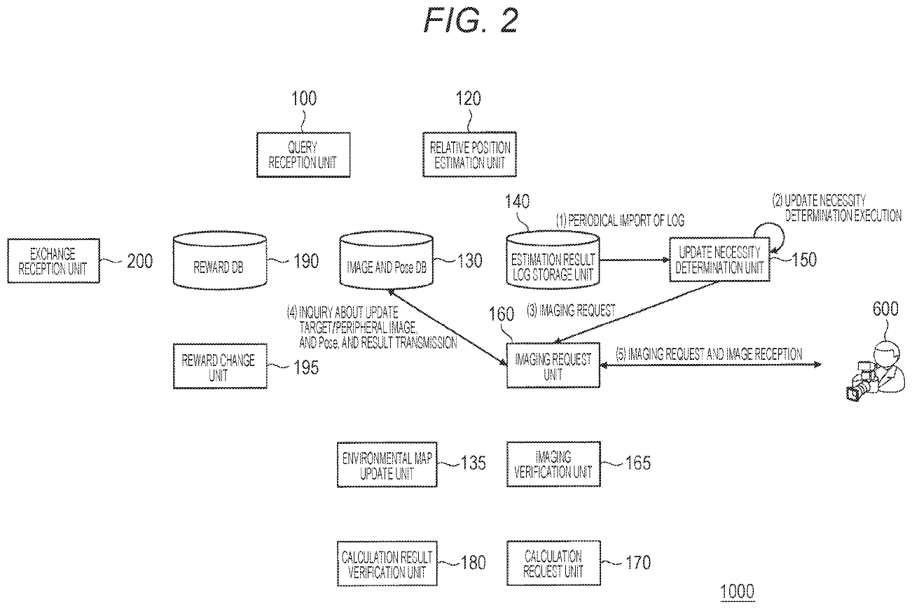

FIG. 2 illustrates processing performed by the update necessity determination unit 150 and the imaging request unit 160. In FIG. 2, an arrow indicates processing related to the determination of update necessity and an imaging request. The update necessity determination unit 150 periodically imports information regarding a log stored in the estimation result log storage unit 140, and on the basis of the information regarding a log, determines whether or not an environmental map stored in the image database 130 needs to be updated. The determination here is performed on the basis of a reprojection error, the number of matched feature points, the number of matchings, and the like. At least in a case where a reprojection error is large, the number of matched feature points is small, or the number of matchings is small, the accuracy of matching is expected to be relatively low. Thus, it is determined that images accumulated in the image database 130 need to be updated. Note that update necessity determination can be performed for each region of an environmental map.

For example, in a case where a captured image includes constructions such as buildings, in a case where a part of buildings in the image has been rebuilt, the number of matched feature points becomes small, and the accuracy of matching of the captured image with respect to an image of an environmental map becomes low. In a similar manner, in a case where a captured image includes trees, for example, in a case where trees grow and change, the number of matched feature points becomes small, and the accuracy of matching of the captured image with respect to an image of an environmental map becomes low. Thus, it is determined that information regarding an environmental map in the image database 130 needs to be updated for the region.

Furthermore, when the self-position of the user 500 is to be estimated as described above, an image similar to the image captured by the user 500 is extracted from the image database 130. Because an image dissimilar to the image captured by the user 500 is not extracted from the image database 130, matching is not performed. Accordingly, among images accumulated in the image database 130, images having small numbers of matchings (numbers of trials) might be different from an actual captured image. The update necessity determination unit 150 also determines that such images need to be updated, on the basis of the number of matchings.

If it is determined by the update necessity determination unit 150 that an environmental map in the image database 130 needs to be updated, information indicating the determination result is transmitted to the imaging request unit 160. At this time, information regarding a position of a region required to be updated may be transmitted to the imaging request unit 160. The imaging request unit 160 inquires of the image database 130 about an update target image and a peripheral image thereof. In response to the inquiry, the image database 130 transmits an update target image and a peripheral image thereof to the imaging request unit 160.

The imaging request unit 160 issues an imaging request to a user who can access the system 1000. The request is broadly issued to general users who can access the system 1000. An imaging request is performed by issuing an imaging request by designating request content (including information regarding an imaging location) on a message board on a Web, for example, but a method of a request may be any method.

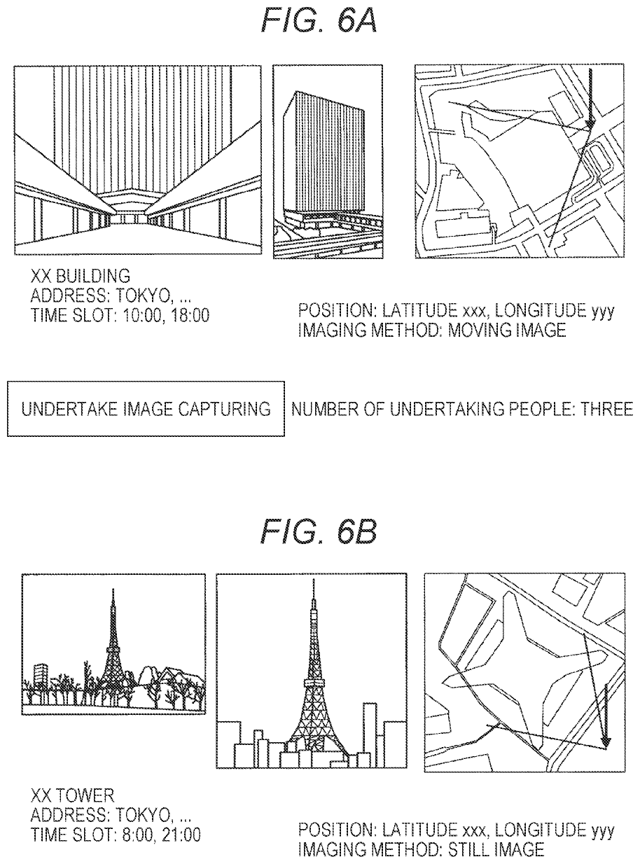

FIGS. 6A and 6B are schematic diagrams illustrating a UI of an imaging request. For example, by displaying a screen illustrated in FIG. 6A or 6B, on a Web, the system 1000 issues an imaging request. FIG. 6A illustrates an example in which an imaging request is issued for a XX building. Furthermore, FIG. 6B illustrates an example in which an imaging request is issued for a XX tower. As illustrated in FIGS. 6A and 6B, an imaging request is issued by designating an address of an imaging location, a time slot of image capturing, a position (latitude, longitude), an imaging method (moving image, still image), and the like. Furthermore, on the UI of the imaging request, an image direction is designated on a map. As an example, as illustrated in FIG. 6A, a button indicating “undertake image capturing” is displayed on the UI of the imaging request. A user who accedes to the imaging request can undertake image capturing by clicking or tapping this button. Note that FIG. 6A illustrates that the number of people undertaking image capturing is three. In such a case, among captured images obtained from the three photographers, an image most appropriate for the update of an environmental map can be employed, and a reward can be allocated to a user who has captured the employed image.

A user 600 who has recognized an imaging request performs image capturing on the basis of content of the imaging request, and transmits a captured image and a peripheral image thereof, and information indicating a rough position of an imaging location, to the system 1000. The imaging request unit 160 receives information including the captured image that has been transmitted from the user 600. The information received by the imaging request unit 160 includes a user ID for identifying the user 600.

Furthermore, the user 600 who desires to receive an imaging request may access the system 1000, and inquire whether or not an imaging request has been issued. In this case, the user 600 who has recognized on the basis of its action that an imaging request has been issued performs image capturing on the basis of content of the imaging request, and transmits a captured image to the system 1000.

### 2.3. Validity Check of Image and Calculation Request

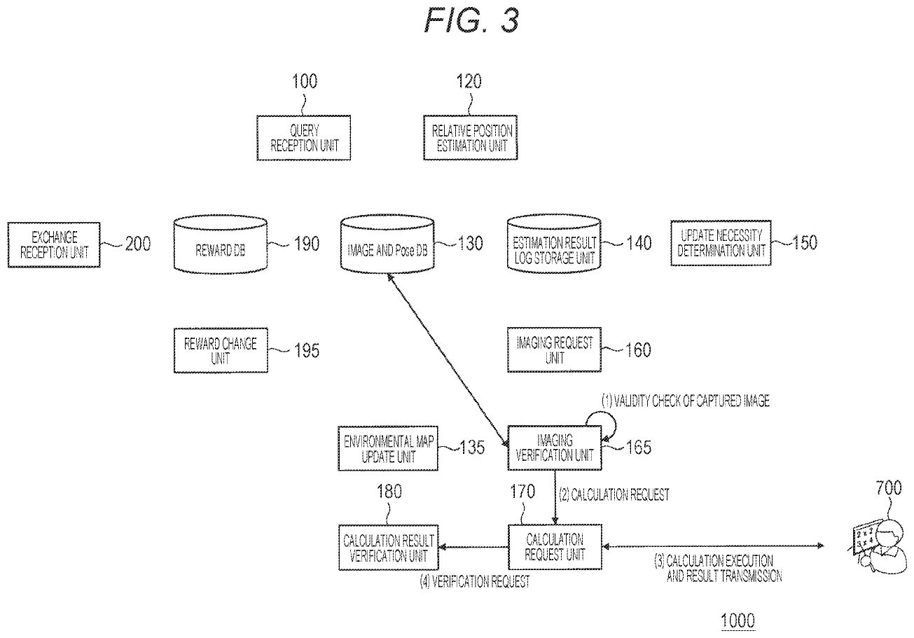

FIG. 3 illustrates processing related to validity check of an image and a calculation request. In FIG. 3, an arrow indicates processing related to validity check and a calculation request. Information including a captured image that has been received by the imaging request unit 160 from the user 600 is transmitted to the imaging verification unit 165. In the imaging verification unit 165, in accordance with the imaging request issued by the imaging request unit 160, verification of validity of the image captured by the user 600 is performed. The verification of validity is performed from the viewpoint of whether or not the image captured by the user 600 is similar to a peripheral image in an environmental map, whether or not the image is clear, and whether or not a moving object is included. As described above, the user 600 transmits information indicating a rough position of an imaging location, to the system 1000, and position information is allocated to an image of an environmental map in the image database 130. Accordingly, the imaging verification unit 165 can extract an image in the image database 130 that corresponds to the image captured by the user 600, and on the basis of the extraction result, check whether or not the image captured by the user 600 is similar to a peripheral image in the environmental map.

More specifically, a major portion of the image captured by the user 600 is highly likely to correspond to a portion in the environmental map that is required to be updated. On the other hand, because the portion in the environmental map that is required to be updated is different from the current landscape due to rebuilding of constructions, growth of trees, or the like, it is expected to be difficult to perform direct matching with the captured image. Thus, preferably, it is desirable to perform matching of the image captured by the user 600 and a peripheral image of the portion required to be updated. Then, on the basis of a result of matching, it is checked whether or not the image captured by the user 600 is similar to a peripheral image in the environmental map.

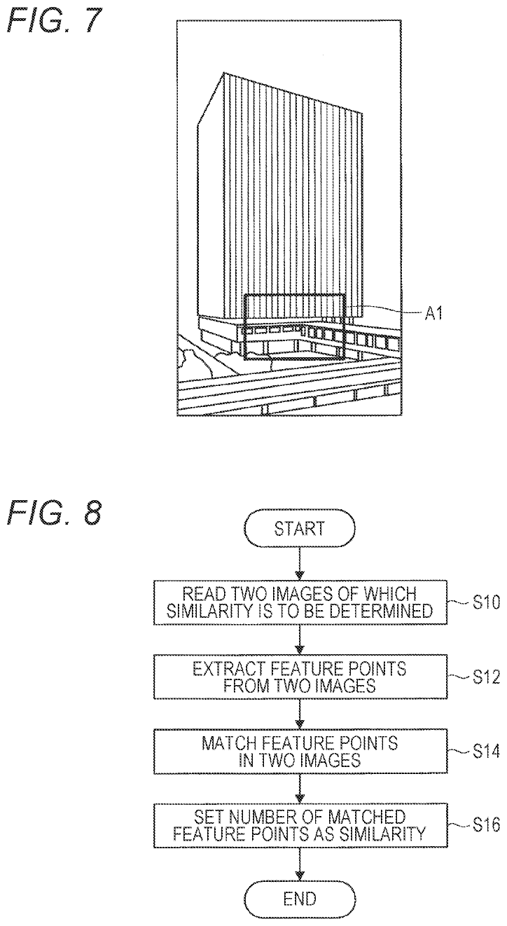

FIG. 7 illustrates, as a region A1, a portion in an environmental map that is required to be updated, in a case where an imaging request is issued for the XX building illustrated in FIG. 6. In this case, by performing matching of a peripheral image of the region A1 in the environmental map and the captured image captured by the user 600, it is checked whether or not the image captured by the user 600 is similar to the peripheral image in the environmental map. More specifically, the user 600 is requested to capture an image larger than the region A1, and matching of an environmental map and the captured image is performed using a region in which the peripheral image of the region A1 in the environmental map and the captured image overlap. In a case where matching succeeds, the environmental map in the region A1 is updated.

The determination as to whether or not the image captured by the user 600 is clear is performed in such a manner that the image is determined to be clearer as calculated frequency of the captured image becomes higher. Furthermore, the determination as to whether or not a moving object is included is performed by performing segmentation of an object in a captured image, by a method such as machine learning, for example, and determining whether or not an object obtained by segmentation is a movable object such as a human or an automobile. Furthermore, a ratio of a moving object with respect to the entire image may be obtained.

As a result of validity check, in a case where the captured image captured by the user 600 is not similar to a peripheral image in an environmental map, in a case where the captured image is not clear, or in a case where a moving object is included in the captured image at a fixed percentage or more, the image captured by the user 600 can be excluded without being employed.

The calculation request unit 170 issues a request to calculate a positional relationship between images of environmental maps accumulated in the image database 130, and the captured image captured by the user 600 in response to the request from the imaging request unit 160. The request is also broadly issued to general users who can access the system 1000. A calculation request is performed by issuing a calculation request by designating request content on a message board on a Web, for example, but a method of a request may be any method.

The calculation request unit 170 transmits an update target image of an environmental map and a peripheral image in the image database 130, and the image transmitted from the user 600, to a user 700 who has acceded to the calculation request, and issues a calculation request to the user 700. Specifically, the calculation request unit 170 issues a request to calculate a relative positional relationship and a reprojection error of images accumulated in the image database 130 and the image captured by the user 600. The user 700 who has performed calculation in response to the request from the calculation request unit 170 calculates a relative positional relationship and a reprojection error, and replies a calculation result to the calculation request unit 170 together with a user ID. The calculation request unit 170 requests the calculation result verification unit 180 to perform verification of calculation performed by the user 700.

### 2.4. Verification of Calculation Result, Update of Environmental Map, and Allocation of Reward

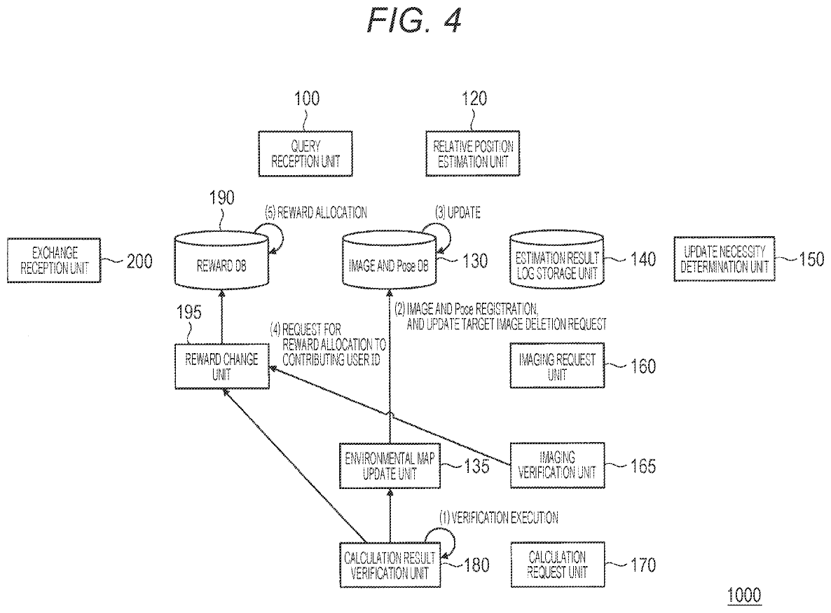

FIG. 4 illustrates processing related to verification of a calculation result, update of an environmental map, and allocation of a reward. In FIG. 4, an arrow indicates processing related to verification of a calculation result, update of an environmental map, and allocation of a reward. The calculation result verification unit 180 verifies a calculation result transmitted from the user 700. In a case where the calculation result has no problem, the calculation result verification unit 180 arranges the image captured by the user 600, at a corresponding position in the environmental map, and checks whether or not an error value is a reasonable numerical value. Then, in a case where an error value is a reasonable numerical value, such as a case where an error value is equal to or smaller than a predetermined threshold, for example, the calculation result verification unit 180 issues an update request of an environmental map to the environmental map update unit 135. The verification of a calculation result is performed by verifying whether or not an error value of feature points in the environmental map and the captured image is reasonable, using the region in which the peripheral image of the region A1 in the environmental map and the captured image overlap, which has been described with reference to FIG. 7.

The environmental map update unit 135 issues an image registration request, and issues a registration request of the image captured by the user 600, into the image database 130, and a deletion request of an update target image of the environmental map from the image database 130. The environmental map update unit 135 updates the image database 130 by performing registration of the image captured by the user 600, into the image database 130, and deletion of the update target image from the image database 130.

The imaging verification unit 165 issues a request to the reward data change unit 195 in such a manner as to allocate a reward to the user 600 who has acceded to the imaging request. Furthermore, the calculation result verification unit 180 issues a request to the reward change unit 195 in such a manner as to allocate a reward to the user 700 who has acceded to the calculation request. A reward of each user who uses the system 1000 is recorded in the reward database 190 together with a user ID. The reward change unit 195 allocates rewards to contributing user such as the users 600 and 700, by changing rewards in the reward database 190. By issuing a reward allocation request from the imaging verification unit 165 and the calculation result verification unit 180 while designating IDs of contributing users, the reward change unit 195 can change rewards in the reward database 190 on the basis of the user IDs.

As an example, a reward is allocated to the user 600 who has acceded to the imaging request, by a predefined reward amount per image, or by a reward amount per moving image. Furthermore, a larger reward may be allocated to the user 600 whose captured image is registered into the image database 130 as an environmental map. Furthermore, a reward amount may be changed in accordance with the accuracy of the image captured by the user 600. For example, a larger reward may be allocated as the accuracy of matching of the image captured by the user 600 and the image of the environmental map becomes higher. Furthermore, a larger reward may be allocated as the image captured by the user 600 becomes clearer. Furthermore, a larger reward may be allocated as a ratio of a moving object included in the image captured by the user 600 becomes smaller. Furthermore, a larger reward may be allocated to the user 600 as the captured image becomes closer to an image desired by the system 1000. Furthermore, a larger reward may be allocated to the user 600 as the number of captured images becomes larger or a moving image recording time becomes longer. Furthermore, a larger reward may be allocated to a user who has performed image capturing at a location where it is difficult to perform image capturing. Moreover, a larger reward may be allocated to a user who has responded to the imaging request more quickly among users who have acceded to the imaging request.

Furthermore, a reward may be similarly allocated to the user 700 who has acceded to the calculation request, in accordance with a calculation amount or the accuracy of calculation. For example, a larger reward may be allocated as a calculation amount becomes larger or the accuracy of calculation becomes higher. Furthermore, a larger reward may be allocated to the user 600 whose calculated image is registered into the image database 130 as an environmental map. Furthermore, a larger reward may be allocated in accordance with an amount of the calculated image or resolution, as an amount of the image becomes larger or resolution becomes higher. Furthermore, a larger reward may be allocated as the number of feature points in the image becomes larger. Furthermore, a larger reward may be allocated to a user who has responded to the calculation request more quickly. Furthermore, an authority to allocate a reward may be given to a user who has completed calculation earliest and transmitted a result.

As described above, when a reward is allocated, it is preferable to allocate a larger reward to a user with a higher contribution degree in accordance with a contribution degree.

### 2.5. Exchange of Reward

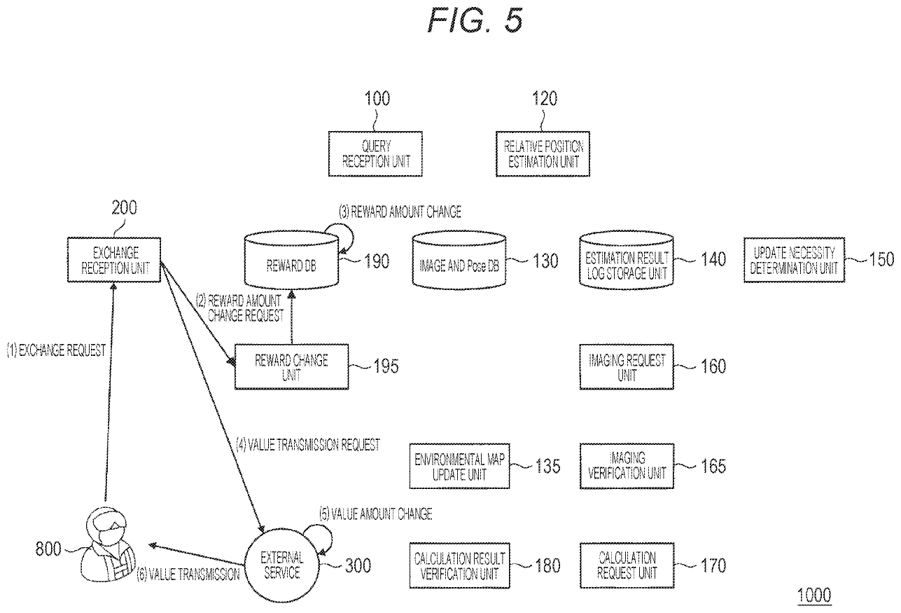

FIG. 5 illustrates a case where a reward is exchanged into another value. In FIG. 5, an arrow indicates processing related to exchange of a reward. A user 800 who requests a reward to be exchanged into another value issues a value exchange request of a reward to the exchange reception unit 200. Note that a user ID of the user 800 is transmitted to the exchange reception unit 200 together with the request. Upon receiving the request, the exchange reception unit 200 issues a reward amount change request to the reward change unit 195 on the basis of request content and the user ID of the user 800. Upon receiving the reward amount change request, the reward change unit 195 changes a reward in the reward database 190 as for a reward corresponding to the user ID of the user 800.

Furthermore, the exchange reception unit 200 transmits a reward change amount to an external service 300, and issues a request to transmit a new value attributed to a reward amount change, to the user 800. The external service 300 converts a reward amount change amount into a new value, and provides a value corresponding to a reward amount change, to the user 800.

### 3. Specific Processing Performed in System

### 3.1. Similarity Determination of Images

Hereinafter, specific processing performed in the system 1000 will be described. FIG. 8 is a flowchart illustrating processing of performing similarity determination of images. The similarity determination of images is performed when the relative position estimation unit 120 performs matching of the captured image of the user 500 and images accumulated in the image database 130, when the imaging verification unit 165 performs similarity determination of a captured image and a peripheral image in an environmental map, and the like.

As illustrated in FIG. 8, first of all, in Step S10, two images of which similarity is to be determined are read. Next, in Step S12, feature points are extracted from the two images. In next Step S14, matching of feature points in the two images is performed. In next Step S16, the number of matched feature points is set as a similarity. Note that a known method can be appropriately used for similarity determination of images.

### 3.2. Clearness Determination of Image

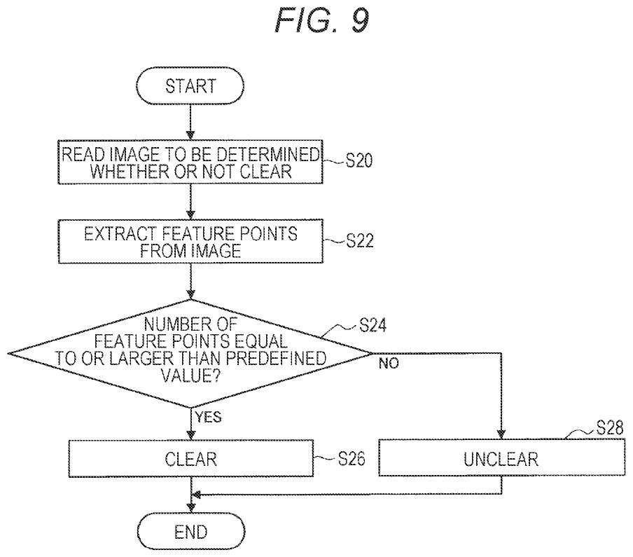

FIG. 9 is a flowchart illustrating processing of performing clearness determination of an image. The clearness determination of an image is performed when the imaging verification unit 165 checks the validity of the captured image of the user 600. First of all, in Step S20, an image to be determined whether or not clear is read. In next Step S22, feature points are extracted from the image. In next Step S24, it is determined whether or not the number of feature points is equal to or larger than a predefined value. In a case where the number of feature points is equal to or larger than a predefined value, the processing proceeds to Step S26, in which it is determined that the image is clear. On the other hand, in a case where the number of feature points is smaller than the predefined value, the processing proceeds to Step S28, in which it is determined that the image is unclear.

Note that, in the processing illustrated in FIG. 9, a clear image obtained by capturing an image of a white wall or the like might be determined to be unclear, but this does not matter because an image with a small number of feature points is difficult to be used as an environmental map. In this manner, in the determination of clearness, processing is performed while placing a priority on selecting an image appropriate as an environmental map.

Furthermore, as described above, a method that uses the frequency of an image can also be used for the clearness determination of an image, in addition to the processing illustrated in FIG. 9.

### 3.3. Determination as to Whether or Not Moving Object Is Included in Image

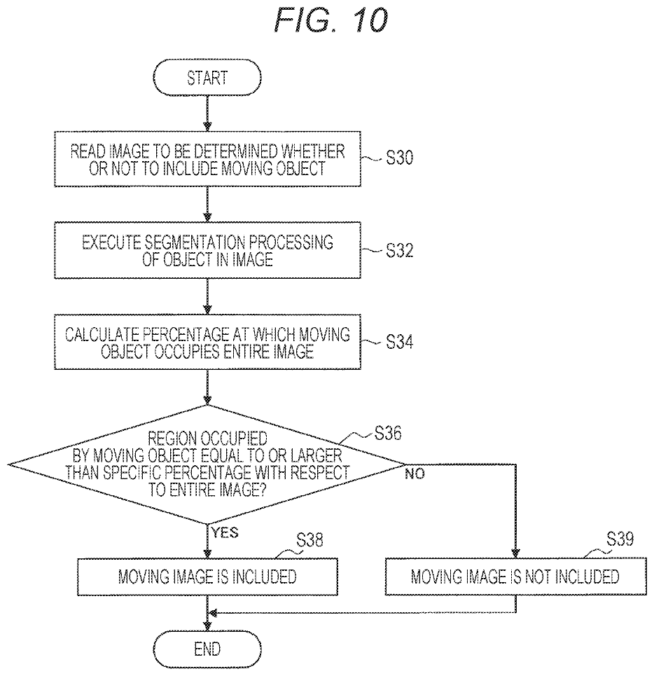

FIG. 10 is a flowchart illustrating processing performed when it is determined whether or not a moving object is included in an image. The determination as to whether or not a moving object is included in an image is also performed when the imaging verification unit 165 checks the validity of the captured image of the user 600. First of all, in Step S30, an image to be determined whether or not to include a moving object is read. In next Step S32, segmentation processing of an object in the image is performed. A framework such as deep learning or manual labeling can be used for segmentation. In next Step S34, a percentage at which a moving object such as a human or au automobile occupies the entire image as a result of segmentation is calculated. In next Step S36, it is determined whether or not a region occupied by the moving object is equal to or larger than a specific percentage with respect to entire image. In a case where the region is equal to or larger than a specific percentage, the processing proceeds to Step S38, in which it is determined that a moving object is included in the image. On the other hand, in a case where the region occupied by the moving object is smaller than the specific percentage with respect to entire image, the processing proceeds to Step S39, in which it is determined that a moving object is not included in the image.

### 3.4. Matching and Relative Position Calculation

In the processing, a relative positional relationship between images is obtained using a Structure from Motion (SfM). In the process of the processing, positions of feature points in images, and positions of feature points common to the images are obtained. For example, the processing can be applied to processing in the relative position estimation unit 120, the imaging verification unit 165, and the calculation result verification unit 180.

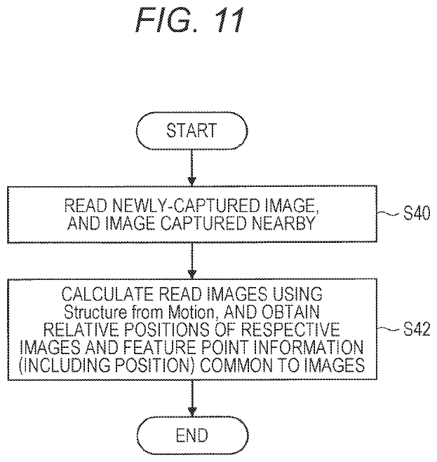

As illustrated in FIG. 11, first of all, in Step S40, a newly-captured image and an image captured nearby are read. In next Step S42, the read images are calculated using the Structure from Motion, and relative positions of the respective images, and feature point information (including position) common to the images are obtained.

### 3.5. Verification Method of Relative Position

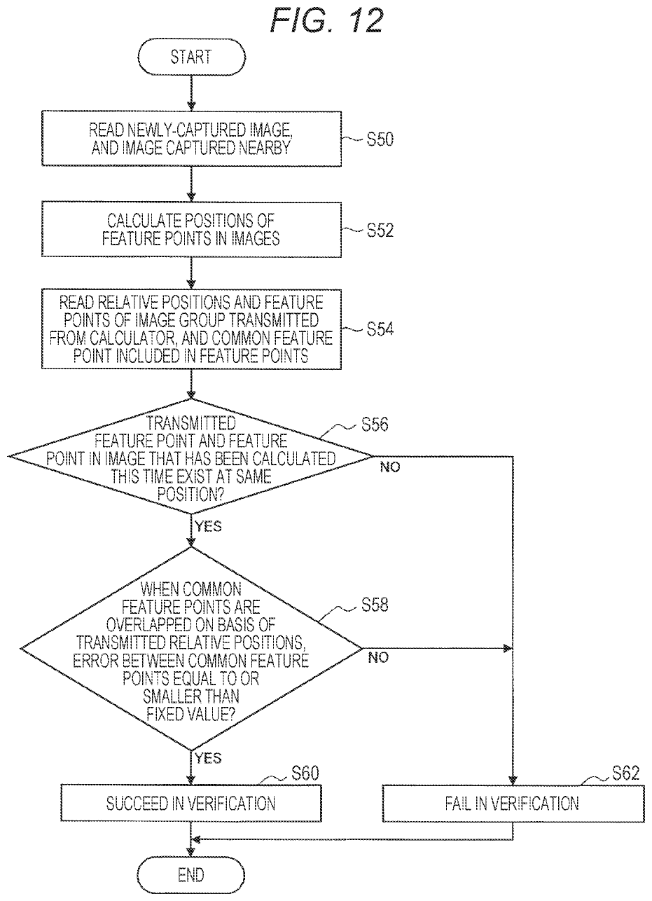

FIG. 12 is a flowchart illustrating processing of a verification method of relative positions of images. The verification of relative positions of images is performed when the calculation result verification unit 180 verifies a calculation result transmitted from the user 700. First of all, in Step S50, a captured image newly-captured by the user 600, and an image captured near the captured image in the environmental map stored in the image database 130 are read. In next Step S52, positions of feature points in the images read in Step S50 are calculated. Note that, in Step S52, a calculation result of the position of an existing feature point may be read. Furthermore, the processing in Step S52 can be performed by the user 700, who is a calculator.

In next Step S54, relative positions and feature points of an image group transmitted from the user 700, who is a calculator, and a common feature point included in the feature points are read. In next Step S56, it is determined whether or not feature points in the captured image newly-captured by the user 600 and feature points in an image in an environmental map that have been calculated by the user 700 exist at the same positions. In a case where the feature points exist at the same positions, the processing proceeds to Step S58. On the other hand, in a case where feature points in the captured image newly-captured by the user 600 and the calculated feature points in an image in an environmental map do not exist at the same positions, the processing proceeds to Step S62, in which it is determined that verification has failed.

In Step S58, when feature points common to the captured image newly-captured by the user 600, and the image in the environmental map are overlapped on the basis of relative positions transmitted from the user 700, who is a calculator, it is determined whether or not an error between the common feature points is equal to or smaller than a fixed value of the number of pixels. In a case where an error is equal to or smaller than the fixed value, the processing proceeds to Step S60. In a case where the processing proceeds to Step S60, it is determined that verification has succeeded. On the other hand, in a case where an error between the common feature points exceeds the fixed value, the processing proceeds to Step S62, in which it is determined that verification has failed. In a case where verification has succeeded, an environmental map is updated by the environmental map update unit 135.

Heretofore, a preferred embodiment of the present disclosure has been described in detail with reference to the attached drawings, but the technical scope of the present disclosure is not limited to this example. It should be appreciated that a person who has general knowledge in the technical field of the present disclosure can conceive various change examples and modified examples within the scope of the technical idea described in the appended claims, and these change examples and modified examples are construed as naturally falling within the technical scope of the present disclosure.

Furthermore, the effects described in this specification are merely provided as explanatory or exemplary effects, and the effects are not limited. That is, the technology according to the present disclosure can bring about another effect obvious for the one skilled in the art, from the description in this specification, in addition to the above-described effects or in place of the above-described effects.

Note that the following configurations also fall within the technical scope of the present disclosure.

(1) An information processing apparatus including:

an imaging request unit configured to issue a request for imaging capturing for updating an environmental map including image information; and an environmental map update unit configured to update the environmental map on the basis of a captured image captured in accordance with the request for the image capturing.

(2) The information processing apparatus according to (1) described above, including:

a relative position estimation unit configured to estimate a relative position of an image transmitted from a user, on the basis of the environmental map; and

an update necessity determination unit configured to determine update necessity of the environmental map on the basis of an estimation result of the relative position that has been obtained by the relative position estimation unit.

(3) The information processing apparatus according to (2) described above, in which the update necessity determination unit determines the update necessity on the basis of a number of matched feature points, a number of trials of matching, or a reprojection error in matching performed when the relative position estimation unit estimates the relative position.

(4) The information processing apparatus according to (2) or (3) described above, in which the environmental map update unit performs the update for a region in the environmental map that is determined by the update necessity determination unit to require update.

(5) The information processing apparatus according to any of (2) to (4) described above, in which the imaging request unit issues a request for image capturing for a region in the environmental map that is determined by the update necessity determination unit to require update.

(6) The information processing apparatus according to any of (1) to (5) described above, including:

an imaging verification unit configured to verify the captured image,

in which the imaging verification unit verifies validity of the captured image on the basis of a similarity of the captured image and the environmental map, clearness of the captured image, or a percentage of a moving object included in the captured image.

(7) The information processing apparatus according to (6) described above, in which the environmental map update unit does not perform update of the environmental map that is based on the captured image, if it is determined by the imaging verification unit that validity of the captured image is low.

(8) The information processing apparatus according to any of (1) to (7) described above, including:

a calculation request unit configured to issue a request for calculation of a relative positional relationship between the captured image and the environmental map,

in which the environmental map update unit updates the environmental map on the basis of the positional relationship transmitted from a user in accordance with the request for the calculation.

(9) The information processing apparatus according to (8) described above, including: a calculation result verification unit configured to verify a calculation result obtained in accordance with the request for the calculation.

(10) The information processing apparatus according to (9) described above, in which the calculation result verification unit positions the captured image onto the environmental map on the basis of the positional relationship obtained in accordance with the request for the calculation, and verifies the calculation result on the basis of matching of feature points in the captured image and feature points in an image of the environmental map.

(11) The information processing apparatus according to any of (1) to (10) described above, including: a reward change unit configured to change a reward of a user who has captured the captured image in accordance with the request for the image capturing.

(12) The information processing apparatus according to any of (8) to (10) described above, including: a reward change unit configured to change a reward of a user who has performed calculation in accordance with the request for the calculation.

(13) An information processing method including:

issuing a request for imaging capturing for updating an environmental map including image information; and

updating the environmental map on the basis of a captured image captured in accordance with the request for the image capturing.

(14) A program for causing a computer to function as:

a means for issuing a request for imaging capturing for updating an environmental map including image information; and

a means for updating the environmental map on the basis of a captured image captured in accordance with the request for the image capturing.

### REFERENCE SIGNS LIST

120 Relative position estimation unit
135 Environmental map update unit
150 Update necessity determination unit
160 Imaging request unit
165 Imaging verification unit
170 Calculation request unit
180 Calculation result verification unit
195 Reward change unit

1. An information processing apparatus comprising:
an imaging request unit configured to issue a request for imaging capturing for updating an environmental map including image information; and
an environmental map update unit configured to update the environmental map on a basis of a captured image captured in accordance with the request for the image capturing.

2. The information processing apparatus according to claim 1, comprising:
a relative position estimation unit configured to estimate a relative position of an image transmitted from a user, on a basis of the environmental map; and
an update necessity determination unit configured to determine update necessity of the environmental map on a basis of an estimation result of the relative position that has been obtained by the relative position estimation unit.

3. The information processing apparatus according to claim 2, wherein the update necessity determination unit determines the update necessity on a basis of a number of matched feature points, a number of trials of matching, or a reprojection error in matching performed when the relative position estimation unit estimates the relative position.

4. The information processing apparatus according to claim 2, wherein the environmental map update unit performs the update for a region in the environmental map that is determined by the update necessity determination unit to require update.

5. The information processing apparatus according to claim 2, wherein the imaging request unit issues a request for image capturing for a region in the environmental map that is determined by the update necessity determination unit to require update.

6. The information processing apparatus according to claim 1, comprising:
an imaging verification unit configured to verify the captured image,
wherein the imaging verification unit verifies validity of the captured image on a basis of a similarity of the captured image and the environmental map, clearness of the captured image, or a percentage of a moving object included in the captured image.

7. The information processing apparatus according to claim 6, wherein the environmental map update unit does not perform update of the environmental map that is based on the captured image, if it is determined by the imaging verification unit that validity of the captured image is low.

8. The information processing apparatus according to claim 1, comprising:
a calculation request unit configured to issue a request for calculation of a relative positional relationship between the captured image and the environmental map,
wherein the environmental map update unit updates the environmental map on a basis of the positional relationship transmitted from a user in accordance with the request for the calculation.

9. The information processing apparatus according to claim 8, comprising: a calculation result verification unit configured to verify a calculation result obtained in accordance with the request for the calculation.

10. The information processing apparatus according to claim 9, wherein the calculation result verification unit positions the captured image onto the environmental map on a basis of the positional relationship obtained in accordance with the request for the calculation, and verifies the calculation result on a basis of matching of feature points in the captured image and feature points in an image of the environmental map.

11. The information processing apparatus according to claim 1, comprising: a reward change unit configured to change a reward of a user who has captured the captured image in accordance with the request for the image capturing.

12. The information processing apparatus according to claim 8, comprising: a reward change unit configured to change a reward of a user who has performed calculation in accordance with the request for the calculation.

13. An information processing method comprising:
issuing a request for imaging capturing for updating an environmental map including image information; and
updating the environmental map on a basis of a captured image captured in accordance with the request for the image capturing.

14. A program for causing a computer to function as:
a means for issuing a request for imaging capturing for updating an environmental map including image information; and
a means for updating the environmental map on a basis of a captured image captured in accordance with the request for the image capturing.
